(19) United States
(12) Patent Application Publication
(10) Pub. No.: US 2010/0252736 A1
(43) Pub. Date: Oct. 7, 2010

(54) IMAGING SYSTEM

(75) Inventors: Peter Michael Thorne, Hampshire (GB); Peter Knowles, Hampshire (GB); Ian M. Baker, Hampshire (GB); Jeremy Crouch, Hampshire (GB); Richard Ash, Hampshire (GB)

Correspondence Address: BUCHANAN, INGERSOLL & ROONEY PC, POST OFFICE BOX 1404, ALEXANDRIA, VA, 22313-1404, US

(73) Assignee: SELEX GALILEO LIMITED, Eessex (GB)

(21) Appl. No.: 12/745,860

(22) PCT Filed: Dec. 9, 2008
(86) PCT No.: PCT/EP2008/067140

§ 371 Date: Jun. 2, 2010

(30) Foreign Application Priority Data
Dec. 10, 2007 (GB) 0724064.1

(51) Int. Cl. H01L 27/146

(52) U.S. Cl. 250/332

(57) ABSTRACT

An imaging system is described which includes a radiation source outputting radiation incident on a scene. The radiation is pulsed and the reflected radiation is detected by a detector array and a resulting signal output by a read out circuit. The signal output is characteristic of the scene on which the radiation is incident. The output signal is combined over a number of pulses, the averaging being carried out on-chip and within the detector circuitry. The radiation source may be a semiconductor diode source amplified with a doped fibre amplifier.

The invention relates to an imaging system. More specifically, but not exclusively, it relates to an imaging system in which infra-red (IR) illumination of a scene of interest is provided using a pulsed IR radiation source and a time gated camera.

In the field of infra-red imaging, systems exist in which infra-red illumination of the scene of interest is provided using a pulsed infra-red laser source and a time gated camera. This allows the camera to record an image at a fixed time after the illumination signal is transmitted and so allows objects within a fixed depth of field from the camera to be discriminated from the foreground and background. This technique also allows a good signal to noise performance as the camera gate only integrates dark current for the duration of the receive gate. The cost, ruggedness, weight, power requirements, and complexity of these systems is strongly influenced by the infra-red source, which may be a diode pumped solid state laser, and may require forced cooling. These factors limit the general use of this technology on the battlefield.

The power needed from such a laser source depends on the size and distance of the object to be viewed, the sensitivity of the camera system, and the signal to noise ratio required at the receiver. Additionally, in systems typically used on airborne platforms a low repetition rate is used and accordingly the detector is not used to its full extent.

According to the invention there is provided an imaging system comprising a pulsed radiation source irradiating a target area and a detector for detecting reflected radiation, the detector outputting a signal characteristic of the scene via a detector read out circuit, in which the output signal from several pulses is combined so as to reduce the effect of noise on the signal, said averaging occurring within the focal plane array of the detector.

One form of the invention will now be described with reference to the accompanying diagrammatic drawings in which;

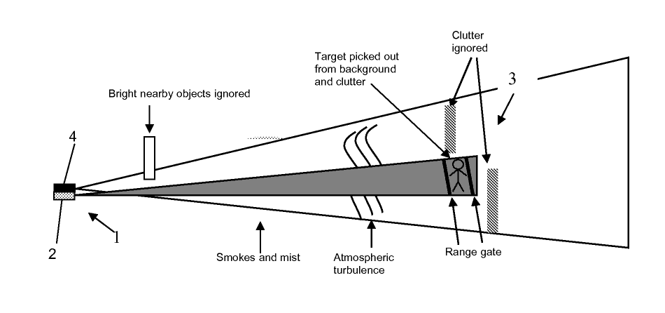

FIG. 1 is a schematic drawing showing one form of the imaging system in operation;

One form of the invention is described below with reference to FIG. 1. The imaging system comprises a pulsed laser source 1 for illuminating a target scene and a detector array. Detectors used in laser gated imaging applications typically integrate the laser return on a small capacitor resulting in a voltage signal. The system further comprises a relatively large sample and hold capacitor that is used to store this voltage signal while the detector senses the next laser return. By continuously sampling the signal, the voltage on the sample and hold capacitance is combined. There is also the benefit of a signal to noise advantage and a signal amplification factor.

Between pulses or bursts the detector array is scanned out, providing larger and more uniform signals than that of a single laser pulse. The scan time of a typical half-TV format array is in the range of a few milliseconds, and this permits frame rates of several hundred Hz. The signal to noise ratio can be enhanced by frame averaging within the camera system so that the displayed image at, for example, 50 Hz is further improved. Averaging within this frequency band also helps to reduce the effects of atmospheric turbulence (speckle). The improvement in signal to noise ratio can be traded for laser power so that the laser power can be met by smaller, less expensive lasers, provided they are capable of the necessary repetition rates.

The signal resulting from laser sources is characterised by high non-uniformity due to coherence effects, such as speckle. It is therefore very useful to average this signal to reduce the non-uniformities. In one form of this invention, averaging is performed within the focal plane array of the detector. A burst of, for example, 8 laser pulses is used. In this time the movement of the image due to platform movement or scintillation and turbulence in the atmosphere is negligible.

An erbium doped fibre amplifier (EDFA) may be used to provide a convenient gain medium which can be used to give a flexible range of output pulses when pumped with a semiconductor laser or LED light source. Other dopant materials are also used, for example (but not limited to) ytterbium, all of which are referred to in this document as EDFAs. This is conventionally known as a MOPA (master oscillator power amplifier) device. The use of LED radiation may give additional advantages in that the broad spectral band presented by the LED (and amplified by the fibre amplifier) will further reduce speckle patterns in the image caused by coherent interference in the source. A similar effect may be achieved by pumping an EDFA with a tuneable laser which can be rapidly tuned using electronic means to change the wavelength during the optical pulse.

The components of an EDFA are light in weight making such laser sources suitable for portable applications. Further enhancements in the ruggedness and portability may be made by incorporating the fibre elements into the casing of the instrument.

For short range systems it is possible to consider direct illumination by a 1550 nm semiconductor laser, for example, with no erbium doped fibre amplifier. This may be either a single element or an array of lasers.

In the embodiment described above, the pulsed laser source may be a GaInAsP based semiconductor laser. However, it will be appreciated that any suitable radiation source capable of operating in the fashion described above may be used.

In the invention described above, the detector is a detector array such as a cooled mercury cadmium telluride focal plane array or a InGaAs photodiode array. However, it will be appreciated that any suitable detector or detector array may be used.

From the foregoing, it will be appreciated that the purpose of this invention is to make use of on-chip signal combination and high repetition rate, pulsed infra-red sources. The advantage is that efficient sources are available of a type that does not necessarily require forced cooling, with associated power consumption, noise, and vibration. Accordingly, smaller systems are achievable that may be used in battlefield situations and other shorter range scenarios rather than being limited to airborne platforms using expensive and high power laser sources.

1. An imaging system comprising:
a pulsed radiation source irradiating a target area: and
a detector for detecting reflected radiation, the detector outputting an output signal characteristic of a scene via a detector read out circuit, in which output signals from several pulses are combined to reduce an effect of noise on the output signal, said combination occurring within a focal plane array of the detector.

2. An imaging system according to claim 1, in which the radiation source is amplified with a doped fibre amplifier.

3. An imaging system according to claim 1, in which the radiation source is a tuneable semiconductor laser.

4. An imaging system according to claim 1, in which the radiation source is a light emitting diode.

5. An imaging system according to claim 2, in which the doped fibre amplifier optical assembly is at least partially integrated into the casing of the instrument.

6. An imaging system according to claim 2, in which the doping in the fibre amplifier is predominantly erbium.

7. An imaging system according to claim 1, in which the radiation source is a semiconductor laser diode or an array of semiconductor laser diodes operating above 1500 nm with sufficiently low power to be considered safe to a human eye.

8. An imaging system according to claim 1 in which the imaging system operates in an infra red range.

9. (canceled)
